(19) United States
(12) Patent Application Publication
(10) Pub. No.: US 2010/0225587 A1
(43) Pub. Date: Sep. 9, 2010

(54) ELECTRONIC DEVICE AND PROGRAM FOR ENTERING CHARACTER

(75) Inventors: Kanae HARADA, Tokyo (JP); Yue Zhang, Kanagawa-ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, TOKYO (JP)

(21) Appl. No.: 12/652,928

(22) Filed: Jan. 6, 2010

(30) Foreign Application Priority Data
Mar. 5, 2009 (JP) P2009-52611

(51) Int. Cl. G06F 3/02

(52) U.S. Cl. 345/168

(57) ABSTRACT

An electronic device which allows an entry of a character string has a display which indicates an entered character, a toggle key adapted for entering a plurality of assigned characters, a shift key adapted for shifting a character entry position on the display, and a controller which allows consecutive first to third operations. The controller is adapted for entering one of the assigned characters at a first position on the display as the first operation. The controller is adapted for shifting the character entry position from the first position to a second position on the display as the second operation. The controller is adapted for displaying one of the assigned characters at the second position on the display as the third operation. The controller is adapted for allowing consecutive two of the first to third operations by means of either one of the toggle key and the shift key.

### CROSS REFERENCE TO RELATED APPLICATIONS

This application is based upon and claims the benefit of priority from the prior Japanese Patent Application No. 2009-52611 filed on Mar. 5, 2009;

the entire contents of which are incorporated herein by reference.

### BACKGROUND OF THE INVENTION

1. Field of the Invention

The present invention relates to an electronic device and a program of the electronic device for entering a character, and in particular to an electronic device having an input section provided with an input key to which a plurality of characters are assigned.

2. Description of the Related Art

A recent trend of small-sized and high-performance electronic devices is accompanied by spread of electronic devices having character entry functions. A mobile phone, one of the electronic devices having character entry functions, provides a character entry function to be used for writing an email, Web browsing and so on.

As being formed into a small-sized one, a mobile phone is provided with a limited number of operation keys to be used for entering characters including an alphabet letter, a Japanese syllabary (hiragana or katakana) letter and a symbol. To a numeric “2” key, e.g., a group of three alphabet letters “A”, “B” and “C” and their lowercases is assigned.

Then, as the “2” key is repeatedly pressed, the three characters are alternately displayed and a desired one of them can be chosen for being entered. As a numeric “3” key is repeatedly pressed, another group of three characters “D”, “E” and “F” and their lowercases are alternately displayed and a desired one of them can be chosen for being entered. A group of Japanese syllabary letters pronounced as “ka”, “ki”, “ku”, “ke” and “ko” is also assigned to the “2” key. If entered and displayed characters change over to the Japanese syllabary letters, the “2” key can similarly be used for entering these characters. Which of the characters of such groups is entered is determined by how many times the operation key is repeatedly pressed.

Further, as chances for entering characters by using a mobile phone increase, mobile phones having dictionary functions of predictable words, Chinese (kanji) characters and often entered phrases, and having word prediction or character string conversion functions come into wide use. A mobile phone having a word prediction function searches a dictionary in accordance with a series of entered characters for a related word, a kanji character or a character string, and displays it as a conversion candidate in a separate area from the series of entered characters. A desired word, a Chinese character or a character string can be chosen from conversion candidates so that a sentence including the chosen word, Chinese character or symbol can be entered.

As mobile phones having such word prediction functions come into wide use, various technologies relating to entering characters are being developed. One example is a mobile phone provided with a right shift key as well as numeric keys. A technology for changing a character entry position of by using a right shift key was developed, as disclosed in Japanese Patent Publication of Unexamined Application (Kokai), No. H10-13523. Then, consider an operation for entering characters belonging to a same character group by using a technology of JP-A-H10-13523 for entering characters. For consecutively entering characters belonging to a same character group by using the technology of JP-A-H10-13523 for entering characters, it is necessary to operate a particular numeric key and the right shift key back and forth.

For consecutively entering two alphabet letters “B” and “C”, e.g., press first the numeric “2” key to which the group of “A”, “B” and “C” is assigned twice so as to enter “B”. Then, press the right shift key so as to shift the character entry position to the right side of the letter “B”. Then, press the “2” key three times so as to enter the letter “C” as a second letter. As positions of the numeric key and the right shift key are usually separate from each other, such a method for entering characters causes poor operability and may possibly cause a problem of pressing a wrong key.

Another related art for easily shifting a character entry position is disclosed in Japanese Patent Publication of Unexamined Application (Kokai), No. 2002-207554. According to JP-A-2002-207554, if key operations are repeated several times, an interval between the key operations is detected. If the interval is longer than a certain period of time, shift the character entry position to the right by one character so as to enter a character corresponding to the operated key to the character entry position after being shifted.

According to JP-A-H10-13523, in a case where characters belonging to a same group are consecutively entered (e.g., consecutively enter “b” and “a”), it is necessary to press the right shift key or a select key after entering the first character by using the operation key to which the first character is assigned, and to press again the same operation key necessary times so as to enter the second character. Thus, the increased number of repeated key operations not only causes poor operability but may possibly cause a wrong operation. According to the character entry technology disclosed in JP-A-2002-207554, then, as a delayed key operation results in the character entry position shifting at undesired timing, an inexperienced operator may possibly take time for entering a desired character.

### SUMMARY OF THE INVENTION

Accordingly, an advantage of the present invention is to provide an electronic device configured to be used for entering a character with a small number of key operations, and to provide a program of the electronic device for entering a character.

To achieve the above advantage, one aspect of the present invention is that an electronic device which allows an entry of a character string has a display which indicates an entered character, a toggle key adapted for entering a plurality of assigned characters, a shift key adapted for shifting a character entry position on the display, and a controller which allows consecutive first to third operations. The controller is adapted for entering one of the assigned characters at a first position on the display as the first operation. The controller is adapted for shifting the character entry position from the first position to a second position on the display as the second operation. The controller is adapted for displaying one of the assigned characters at the second position on the display as the third operation. The controller is adapted for allowing consecutive two of the first to third operations by means of either one of the toggle key and the shift key.

### BRIEF DESCRIPTION OF THE DRAWINGS

FIGS. 1A and 1B show a configuration of a flip-type mobile phone in an open state which is an example of a mobile communication device of an embodiment of the present invention in front and side external views.

FIGS. 2A and 2B show a configuration of the flip-type mobile phone in a closed state which is an example of the mobile communication device of the embodiment of the present invention in front and side external views.

FIG. 3 is a block diagram showing an internal configuration of the mobile communication device of the embodiment of the present invention.

FIG. 4 is a flowchart showing a flow of a process of a first embodiment of the present invention for shifting a character entry position by means of a press and hold operation of a numeric key.

FIG. 5 shows a screen transition on a main display of the first embodiment of the present invention for entering a character string “B” and “C” in the process for shifting the character entry position by means of a press and hold operation of a numeric key.

FIG. 6 shows a screen transition on the main display of the first embodiment of the present invention for entering a character string “B”, a space and “A” in the process for shifting the character entry position by means of a press and hold operation of a numeric key.

FIG. 7 is a flowchart showing a flow of a process of a second embodiment of the present invention for entering a character by means of a press and hold operation of a numeric key.

FIG. 8 shows a screen transition on the main display of the second embodiment of the present invention for entering a character string “B” and “C” in the process for entering a character by means of a press and hold operation of a numeric key.

FIG. 9 is a flowchart showing a flow of a process of a third embodiment of the present invention for changing a character by means of a press and hold operation of a numeric key.

FIG. 10 shows a screen transition on the main display of the third embodiment of the present invention for entering a character string “B” and “C” in the process for changing a character by means of a press and hold operation of a numeric key.

FIG. 11 is a flowchart showing a flow of a process of a fourth embodiment of the present invention for entering a character by pressing a right shift key.

FIG. 12 shows a screen transition on the main display of the fourth embodiment of the present invention for entering a character string “B” and “C” in the process for entering a character by pressing the right shift key.

### DETAILED DESCRIPTION OF THE INVENTION

Embodiments of the present invention will be explained with reference to the drawings, hereafter.

(Configuration of a Mobile Phone)

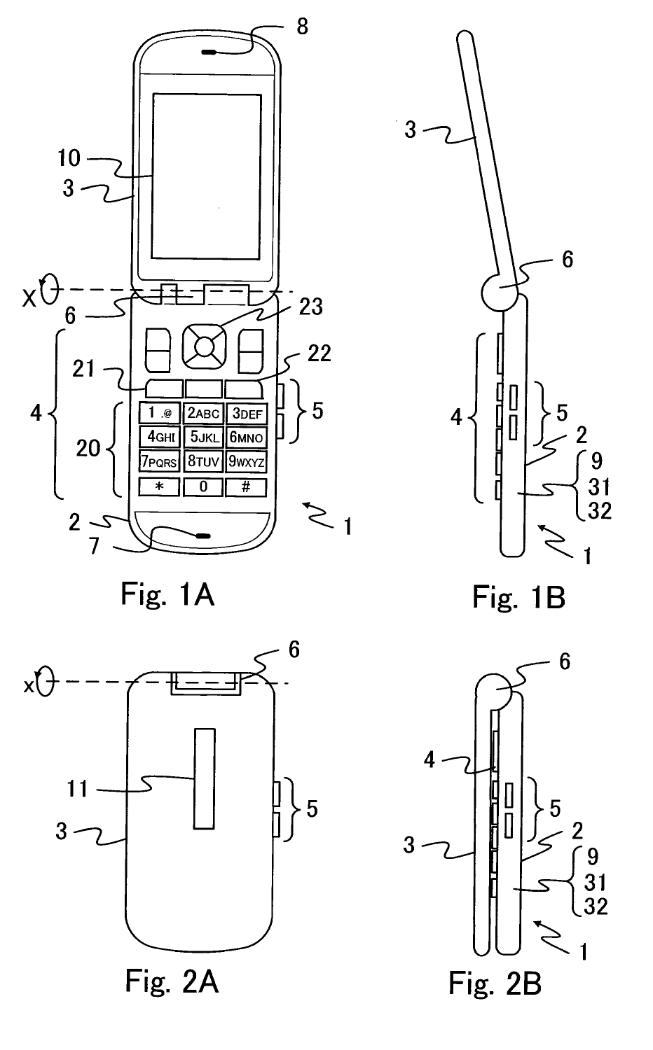

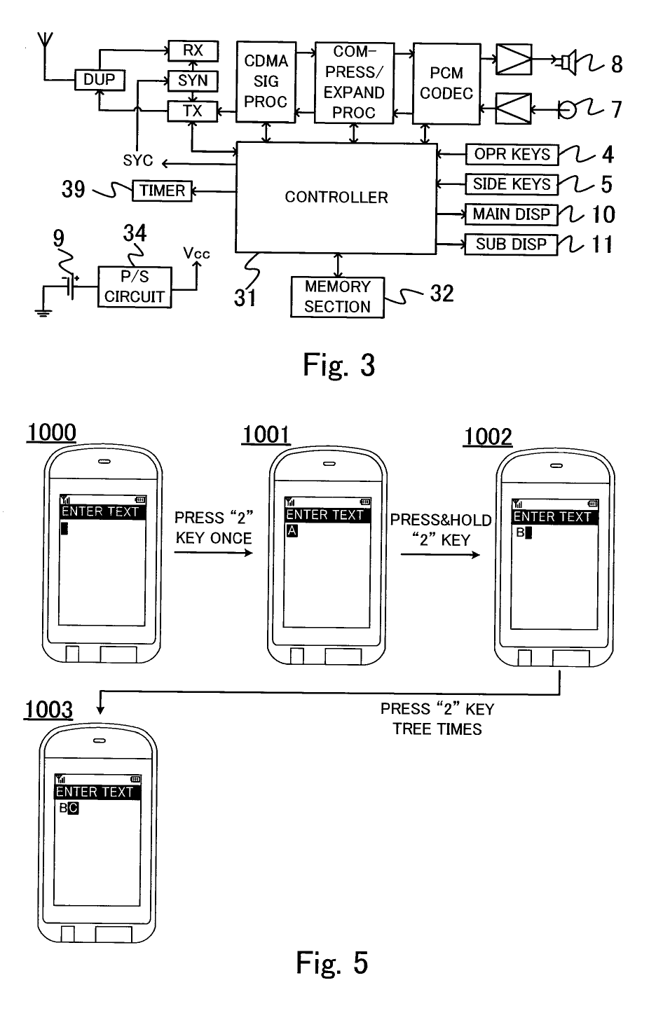

FIGS. 1A and 1B show a configuration of a flip-type mobile phone 1, an example of an electronic device of the present invention, in external views. FIG. 1A shows the configuration in an open state where the mobile phone 1 is open to 180 degrees in an external front view. FIG. 1B shows the configuration in the open state in an external side view. FIGS. 2A and 2B show the configuration of the flip-type mobile phone 1, an example of the electronic device of the present invention, in a closed state in external views. FIG. 2A shows the configuration in the closed state in an external front view. FIG. 1B shows the configuration in the closed state in an external side view. Further, FIG. 3 is a block diagram showing an internal configuration of the mobile phone 1 of the embodiment.

As shown in FIGS. 1A and 1B, the mobile phone 1 is constituted by a first housing section 2 and a second housing section 3 connected to each other through a hinge section 6 provided in the middle of the housing sections 2 and 3. The mobile phone 1 is configured such that the first housing section 2 flips around the hinge section 6 with respect to the second housing section 3 as indicated by an arrow “X”. The mobile phone 1 is provided with a built-in antenna for transmitting and receiving radio waves at a certain position within one of the housing sections 2 and 3. The mobile phone 1 transmits and receives radio waves to and from a base station through the built-in antenna. The radio waves transmitted and received by the mobile phone 1 are modulated for carrying a data signal for data communication such as sending and receiving emails and a voice signal for voice communication for which a microphone 7 and a speaker 8 described later are used. As data and voice communication by way of wireless communication is widely known, its explanation is omitted.

The first housing section 2 is provided on a face of it with operation keys 4 constituted by numeric keys 20 from “0” to “9”, a call key 21, an answer key 22 and a 4-way navigation key 23 to be used for shifting a character entry position up, down, left and right. Further, the mobile phone 1 is provided on a side of it with side keys 5 constituted by a manner mode key and a menu key. Incidentally, the 4-way navigation key 23 includes four shift keys and one of them on the right side is a right shift key described later. A user of the mobile phone 1 enters various instructions or data into the mobile phone 1 by using the operation keys 4 or the side keys 5.

Further, the first housing section 2 is provided with a microphone 7 on a lower side than the operation keys 4, and the microphone 7 collects voice of a user during a voice communication session. Further, the second housing section 3 is provided with a speaker 8 on an upper side than a main display 10 which will be described later, and the speaker 8 produces voice of someone who is calling or called during a voice communication session. The first housing section 2 is provided with a battery on a back of it. If an end key is pressed and held and thus the mobile phone 1 is turned on, the battery 9 supplies each of portions of the mobile phone 1 described later with power through a power supply circuit 34.

The second housing section 3 is provided with the main display 10 on a front face, and the main display 10 displays a setup screen, an email, a Website or an entered character. Incidentally, the main display 10 is formed, e.g., by an LCD (liquid crystal display) or an organic EL (electroluminescent) display. The second housing section 3 is provided on a back with a sub-display 11 formed, e.g., by an LCD. The sub-display 11 displays, e.g., a signal strength indicator indicating strength of a radio wave that the mobile phone 1 is receiving, a battery indicator indicating remaining battery power or present time. Further, the side keys 5 provided to the second housing section 3 is positioned such as to be operated even if the mobile phone 1 is in the closed state.

The first housing section 2 is provided with a controller 31 at an internal position that is not shown. The controller 31 is constituted by electronic circuits such as a CPU (central processing unit), a ROM (read only memory) and a RAM (random access memory). The CPU performs a process in accordance with a program stored in the ROM or various application programs loaded onto the RAM. Further, the CPU processes a signal provided from each of circuit sections described above, and produces various control signals so as to provide each of the circuit sections for controlling the mobile phone 1 with the control signals. The CPU exercises supervisory control over the mobile phone 1 by means of these processes. Further, data necessary for the CPU to perform various processes are stored in the RAM. The controller 31 further has a video RAM in which data relating to an image to be displayed on the main display 10 is stored. A memory section 32 is constituted, e.g., by a flash memory element that is an electrically rewritable or erasable non-volatile memory or an HDD (hard disk drive). If one of the operation keys 4 is pressed and held, a timer 39 detects a period of time for which the key keeps being pressed and held (press and hold time) and notifies the controller 31 of the detected press and hold time.

Various application programs to be run by the CPU of the controller 31 and a group of data are stored in the memory section 32. Further, data of a character group corresponding to each of the numeric keys 20 is stored in the memory section 32. For instance, three alphabet letters “A”, “B”, “C” and their lowercases are assigned to the numeric key “2” and stored in the memory section 32. Five Japanese syllabary letters including a consonant “k” are assigned to the numeric “2” key as well, form a character group with the three alphabet letters so that the character group is stored in the memory section 32. Other alphabet letters and Japanese syllabary letters are severally assigned to other respective numeric keys “3” to “9” similarly as to the numeric “2” key, and some symbols are assigned to the numeric “0” and “1” keys, so that a user distinguishes and presses each of the numeric keys so as to enter a desired letter or symbol.

Incidentally, if a letter “A” is indicated at the character entry position in a character entry process described later, the numeric “2” key is pressed once so that a letter “B” is read out. Similarly, the numeric “2” key is pressed twice so that a letter “C” is read out. If, in such a way, a character entry operation is performed for a character group assigned to each of the numeric keys in accordance with a certain rule, the controller 31 performs a process for reading out a character corresponding to the input operation from the memory section 32. In the memory section 32, each of characters to be entered is stored at a location addressed in accordance with the corresponding numeric key and how many times the numeric key is pressed. Further, so called dictionary data to be used for converting a character string entered through the operation keys 4 and the side keys 5 into a predictable word is stored in the memory section 32. Words or Chinese (kanji) character strings corresponding to entered character strings, symbol strings, history data of used character strings and so on are stored in the dictionary data.

A character string entered by means of the character entry process described later is compared with the dictionary data stored in the memory section 32 so as to be converted into a word, a kanji character string or a symbol string in the dictionary data. If, e.g., alphabet letters “e” and “a” are indicated on the screen in this order, candidate converted words are displayed in a lower portion of the screen. To put it concretely, e.g., candidate converted words “each”, “eagle”, “east”, “eat” and so on are displayed as words in the dictionary data related to the letter string “e” and “a”. If, e.g., a lower soft key is pressed three times so as to choose “eagle”, a certain select key or another numeric key to which another character group is assigned is pressed so that “eagle” is entered and a next character entry operation can be started. A technology for converting a character string into a predictable word, a kanji character string or a symbol string is known, and its explanation is omitted.

### First Embodiment

According to a first embodiment of the present invention, a numeric key is pressed and held so that a character is entered and a character entry position is shifted. According to the first embodiment, characters belonging to a same character group can be consecutively entered by means of simple operation of the numeric keys only. Incidentally, to press and hold a numeric key means an operation of keeping pressing the numeric key for a longer period of time than a certain time length (e.g., half a second).

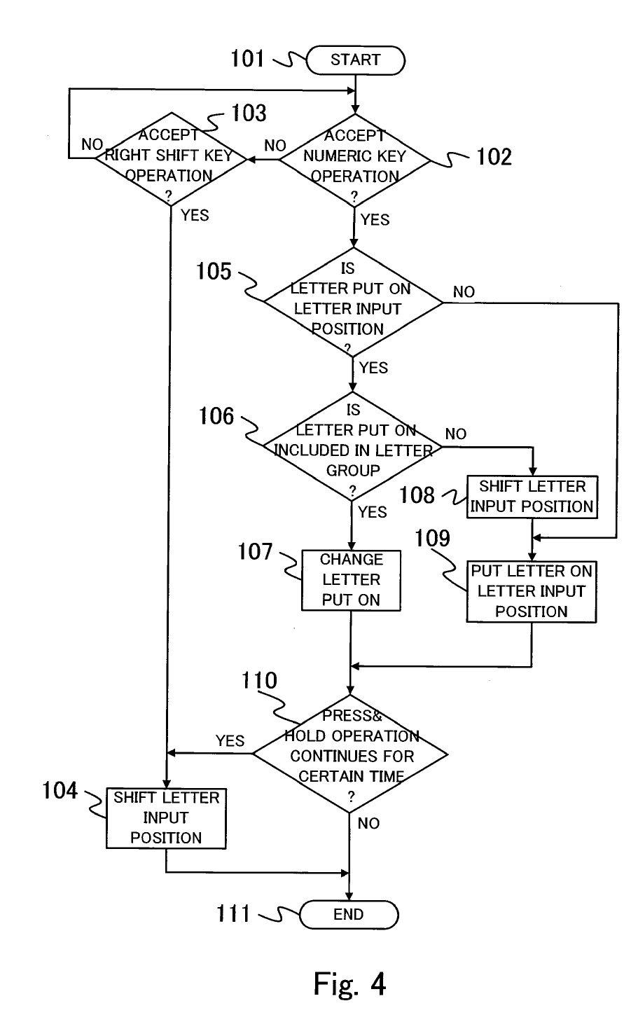

FIG. 4 is a flowchart showing a process for shifting a character entry position by means of a press and hold operation of a numeric key. A process for entering a character string will be described below with reference to FIG. 4.

First, upon starting a character entry process (step 101), the controller 31 accepts an operation of a numeric key or a right shift key (step 102, step 103). Upon accepting an operation of the right shift key (“YES” of step 103), the controller 31 shifts the character entry position one character ahead (step 104) and then ends the process (step 111).

Meanwhile, upon accepting an operation of a numeric key (“YES” of step 102), the controller 31 identifies whether or not a character is already entered on the present character entry position (step 105). Upon identifying no character entered on the character entry position (“NO” of step 105), the controller 31 enters a character assigned to the operation-accepted numeric key on the character entry position (step 109).

If the operation-accepted numeric key is the “2” key, e.g., the alphabet letter “A” assigned to the “2” key is entered on the character entry position. Upon identifying a character already entered on the character entry position (“YES” of step 105), the controller 31 identifies whether or not the already entered character is included in the character group of the operation-accepted numeric key (step 106).

Assume, e.g., that the character already entered on the character entry position is “D”, and that the operation-accepted numeric key is the “2” key. If the characters assigned to the “2” key are three alphabet letters “A”, “B”, “C” and their lowercases as described above, the character “D” is identified as not being included in the above character group. Upon identifying in this way the character already entered on the character entry position as not being included in the character group assigned to the operation-accepted numeric key (“NO” of step 106), the controller 31 shifts the character entry position one character ahead (step 108). Further, the controller 31 enters a character assigned to the operation-accepted numeric key on the character entry position after being shifted (step 109).

Meanwhile, assume, e.g., that the character already entered on the character entry position is a letter “B”, and that the operation-accepted numeric key is the “2” key. In this case, the letter “B” is identified as being included in the character group assigned to the “2” key. Upon identifying in this way the character already entered on the character entry position as being included in the character group assigned to the operation-accepted numeric key (“YES” of step 106), the controller 31 reads out another certain character included in the above character group. The controller 31 changes the character already entered on the character entry position to the character that has been read out.

Assume, e.g., that the character already entered on the character entry position is “B”, and that the operation-accepted numeric key is the “2” key. The controller 31 then reads out the letter “C” that is next to “B” in the three alphabet letters assigned to the “2” key. The controller 31 changes the letter “B” already entered on the character entry position to the letter “C” read out from the memory section 32.

After changing the character, the controller 31 identifies whether or not the operation-accepted numeric key is pressed and held (step 110). Upon identifying the pressed key as not being held (“NO” of step 110), the controller 31 ends the process (step 111). Upon identifying the pressed key as being held (“YES” of step 110), the controller 31 enters the character, shifts the character entry position to a next character entry position and ends the process (step 111).

FIG. 5 shows a transition between screens on which the character entry process shown in FIG. 4 is displayed. A screen transition flow in a case where the letters “B” and “C” are entered will be described with reference to FIG. 5.

According to the character entry process shown in FIG. 4, e.g., in order to enter a letter string “B” and “C”, press first the numeric “2” key to which the letter group “A” to “C” is assigned once, so that a letter “A” is indicated on the screen (refer to a screen 1001 shown in FIG. 5). Then, press and hold the “2” key. Upon detecting the “2” key as being pressed and held for a longer period of time than a certain time length (e.g., half a second), the controller 31 changes the letter “A” indicated on the screen to a letter “B”, enters the letter “B” and shifts the character entry position to a position next to the letter “B”. The character entry position is indicated on the screen at the position next to the letter “B” after being shifted (refer to a screen 1002 shown in FIG. 5). Then, press the “2” key three times so that a letter “C” is indicated at a position next to the letter “B” (refer to a screen 1003 shown in FIG. 5).

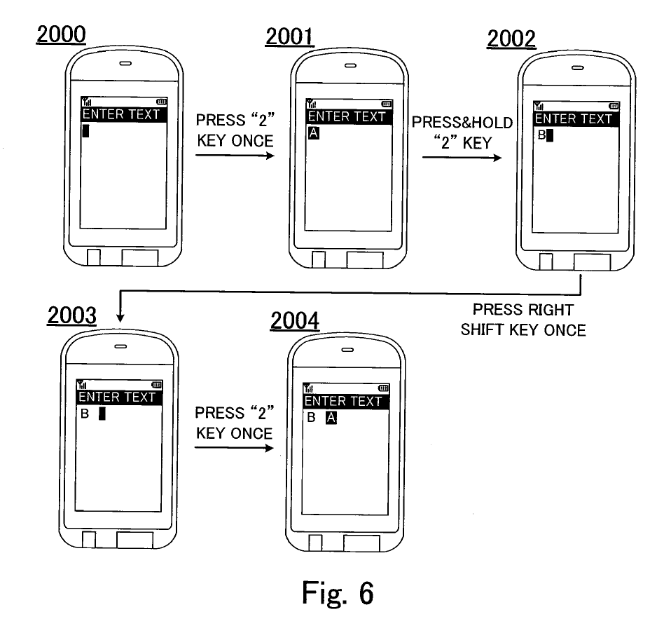

Then, a process for entering a character string including a space in accordance with the character entry process shown in FIG. 4 will be described. FIG. 6 shows a transition between screens in a case where a character string “B”, a space and “C” is entered.

In order to enter a character string, “B”, a space and “C”, press first the numeric “2” key to which the letter group “A” to “C” is assigned, so that a letter “A” is indicated on the screen (refer to a screen 2001 shown in FIG. 6). Then, press and hold the “2” key. Upon detecting the “2” key as being pressed and held for a longer period of time than a certain time length (e.g., half a second), the controller changes the letter “A” indicated on the screen to a letter “B”, enters the letter “B” and shifts the character entry position to a position next to the letter “B”. The character entry position is indicated on the screen at the position next to the letter “B” after being shifted (refer to a screen 2002 shown in FIG. 6). Then, press the right shift key so as to shift rightwards and indicate the character entry position one more character ahead (refer to a screen 2003 shown in FIG. 6). Then, press the “2” key once so that a letter “A” is indicated as a third character (refer to a screen 2004 shown in FIG. 6).

According to the process of the first embodiment described above, even in a case where characters belonging to a same character group are consecutively entered, a simple press and hold operation is used so that an entered character can be changed and a character entry position can be shifted.

### Second Embodiment

According to a second embodiment of the present invention, a numeric key is pressed and held so that a character is entered, a character entry position is shifted to a next position, and a certain character (e.g., the front one) of a character group assigned to the pressed and held numeric key is read out from the memory section 32 and entered on the character entry position that has been shifted. According to the second embodiment, characters belonging to a same character group can be consecutively entered by means of a simple operation of a same numeric key.

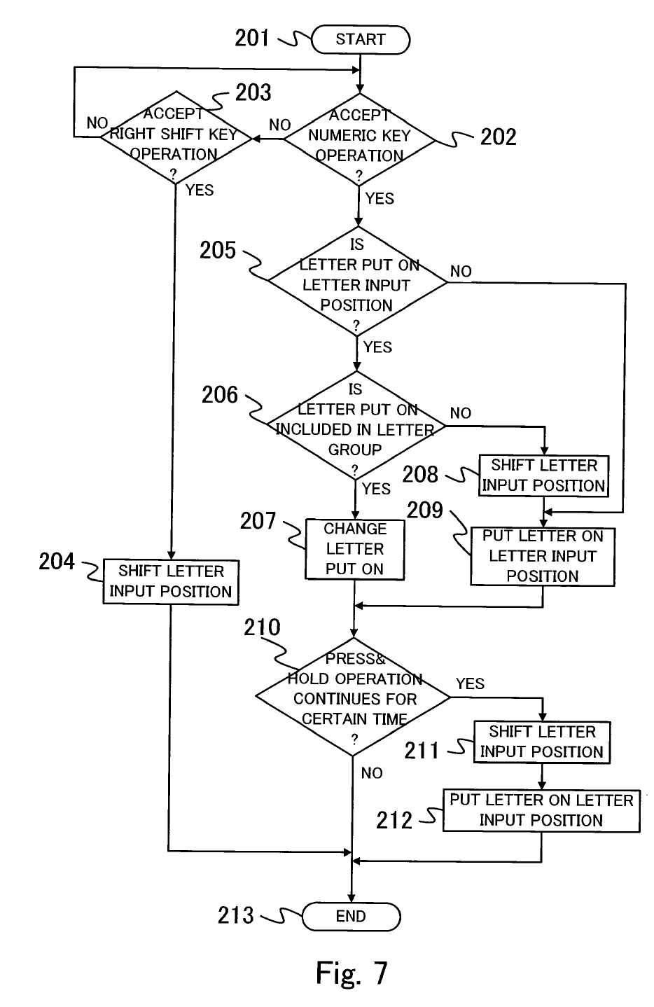

FIG. 7 is a flowchart showing a process for pressing and holding a numeric key so as to shift a character entry position, and further entering a character. A flow of a character entry process will be described below with reference to FIG. 7. Incidentally, as processes of steps 201-209 in the character entry process shown in FIG. 7 are same as the processes of the steps 101-109 in the character entry process shown in FIG. 4, their explanations are omitted. A later portion of the flow followed after the step 206 branches off to “YES” will be explained below.

The controller 31 identifies whether or not a character entered on the character entry position is included in a character group of an operation-accepted numeric key (step 206). Assume, e.g., that the character already entered on the character entry position is a letter “B”, and that the operation-accepted numeric key is the “2” key. In this case, the letter “B” is identified as included in the character group assigned to the “2” key.

Upon identifying in this way the character already entered on the character entry position as being included in the character group assigned to the operation-accepted numeric key (“YES” of step 206), the controller 31 reads out another certain character included in the character group from the memory section 32. The controller 31 changes the character already entered on the character entry position to the read-out character (step 207).

Assume, e.g., that the character already entered on the character entry position is a letter “B”, and that the operation-accepted numeric key is the “2” key. In this case, e.g., the controller 31 reads out the letter “C” that is next to “B” in the three alphabet letters assigned to the “2” key. The controller 31 changes the letter “B” already entered on the character entry position to the letter “C” read out from the memory section 32.

After changing the character, the controller 31 identifies whether or not the operation-accepted numeric key is pressed and held (step 210). Upon identifying the pressed key as not being held (“NO” of step 210), the controller 31 ends the process (step 213). Meanwhile, upon identifying the pressed key as being held (“YES” of step 210), the controller 31 enters the character and shifts the character entry position to a next position (step 211). Then, the controller 31 enters the character assigned to the numeric key that was pressed and held (step S212), and ends the process (step S213). If the operation-accepted numeric key is the “2” key, the controller 31 enters a letter “A” assigned to the “2” key,

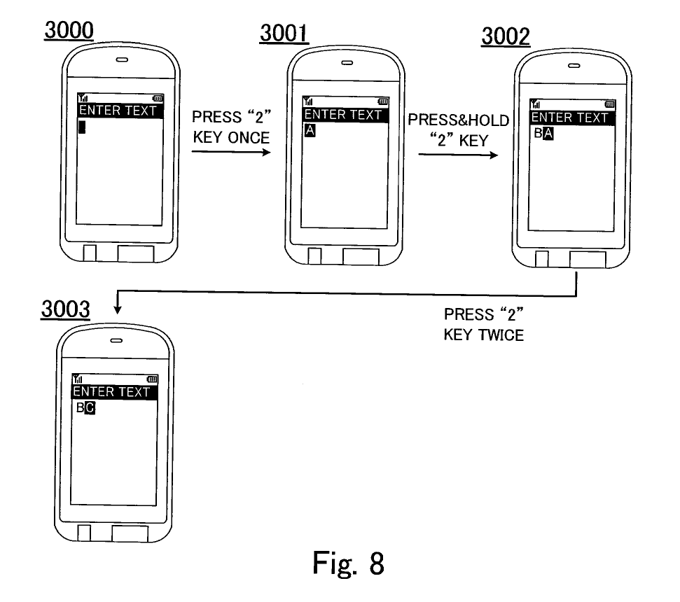

FIG. 8 shows a transition between screens on which the character entry process that uses a press and hold operation of a numeric key is displayed. A screen transition flow in a case where the letters “B” and “C” are entered will be described with reference to FIG. 8.

First, press the numeric “2” key, e.g., to which the letter group “A” to “C” is assigned once, so that a letter “A” is indicated on the screen (refer to a screen 3001 shown in FIG. 8). Then, press and hold the “2” key. Upon detecting the “2” key as being pressed and held for a longer period of time than a certain time length (e.g., half a second), the controller 31 changes the letter “A” indicated on the screen to a letter “B”, enters the letter “B” and then indicates another letter “A” at the next character entry position on the screen (refer to a screen 3002 shown in FIG. 8). Further, press the “2” key twice so as to indicate a letter string “B” and “C” (refer to a screen 3003 shown in FIG. 8).

According to the process of the second embodiment described above, even in a case where characters belonging to a same character group are consecutively entered, an entered character can be changed, a character entry position can be shifted and a character can be entered on the character entry position after being shifted only by means of a simple press and hold operation using the same key as used for entering the character.

### Third Embodiment

According to a third embodiment of the present invention, a numeric key is pressed and held so that a character is entered, a character entry position is shifted to a next position, and a certain character of a character group assigned to the pressed and held numeric key is read out from the memory section 32 and entered on the character entry position that has been shifted. Further, the entered character changes every certain period of time (e.g., half a second) that passes while a pressed numeric key keeps being held. According to the third embodiment, how many times a key is pressed for consecutively entering characters belonging to a same character group can be reduced.

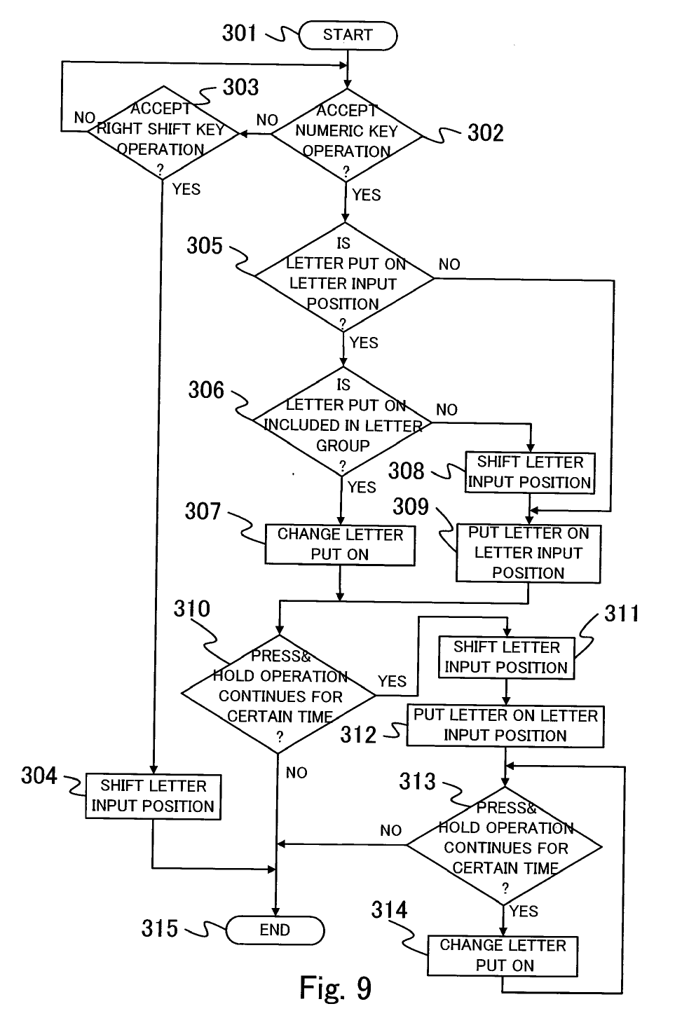

FIG. 9 is a flowchart showing a process, upon a numeric key being pressed and held, for changing a character entered on the character entry position, shifting the character entry position to a next position and further changing the entered character depending on a press and hold time length of the numeric key. A flow of a character entry process will be described below with reference to FIG. 9. Incidentally, as processes of steps 301-309 in the character entry process shown in FIG. 9 are same as the processes of the steps 101-109 in the character entry process shown in FIG. 4, their explanations are omitted. A later portion of the flow followed after the step 306 branches off to “YES” will be explained below.

The controller 31 identifies whether or not a character entered on the character entry position is included in a character group of an operation-accepted numeric key (step 306). Assume, e.g., that the character already entered on the character entry position is a letter “B”, and that the operation-accepted numeric key is the “2” key. In this case, the letter “B” is identified as included in the character group assigned to the “2” key. Upon identifying in this way the character already entered on the character entry position as being included in the character group assigned to the operation-accepted numeric key (“YES” of step 306), the controller 31 reads out another certain character included in the character group from the memory section 32. The controller 31 changes the character already entered on the character entry position to the read-out character (step 307).

Assume, e.g., that the character already entered on the character entry position is a letter “B”, and that the operation-accepted numeric key is the “2” key. The controller 31 reads out the letter “C” that is next to “B” in the three alphabet letters assigned to the “2” key. The controller 31 changes the letter “B” already entered on the character entry position to the letter “C” read out from the memory section 32.

After changing the character, the controller 31 identifies whether or not the operation-accepted numeric key is pressed and held (step 310). Upon identifying the pressed key as not being pressed and held (“NO” of step 310), the controller 31 ends the process (step 315). Upon identifying the pressed key as being pressed and held (“YES” of step 310), the controller 31 shifts the character entry position to a next position (step 311). Then, the controller 31 enters the character assigned to the pressed and held numeric key (step S312).

If the operation-accepted numeric key is the “2” key, e.g., the alphabet letter “A” assigned to the “2” key is entered on the character entry position. Then, the controller 31 recognizes a period of time for which the numeric key keeps being pressed and held by using the timer 39 (step S313). Further, the controller 31 identifies whether or not the numeric key keeps being pressed and held for a certain period of time (e.g., half a second) (step S310). Upon identifying release of the numeric key within the certain period of time (“NO” of step 310), the controller 31 ends the process (step S315).

Meanwhile, upon identifying the numeric key as being pressed and held longer than the certain period of time (“YES” of step 310), the controller 31 enters a letter “A” at the step 312. Assume, on that occasion, that the “2” key keeps being pressed and held. If that is the case, among three alphabet letters assigned to the “2” key, the letter “B” assigned next to the letter “A” is read out from the memory section 32. The controller 31 changes the letter “A” already entered on the character entry position to the letter “B” read out from the memory section 32 (step S314). Returning to the step 313 after the characters are changed as described above, the controller 31 recognizes a period of time for which the numeric key keeps being pressed and held by using the timer 39. If the numeric key still keeps being pressed and held, the controller 31 repeats the processes of the steps 313 and 314 for repeatedly changing the character entered at the step S312.

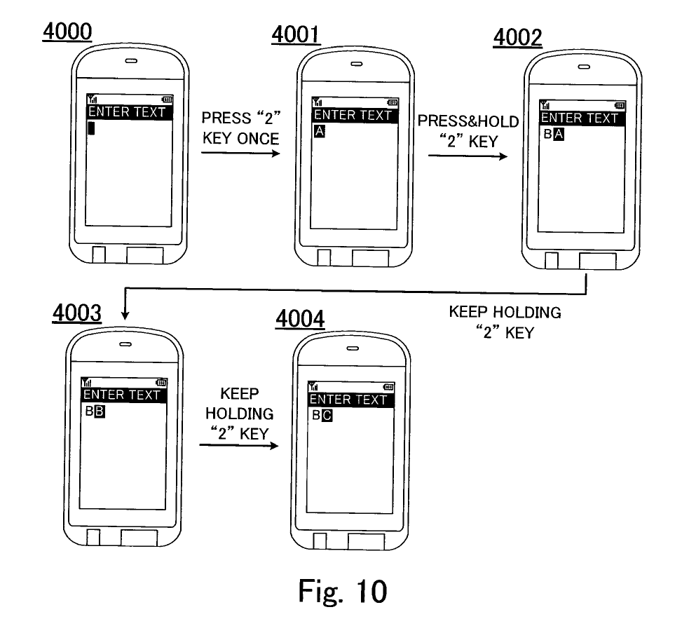

FIG. 10 shows a transition between screens on which the character entry process that uses a press and hold operation of a numeric key is displayed. A screen transition flow in a case where the letters “B” and “C” are entered will be described with reference to FIG. 10.

First, press the numeric “2” key, e.g., to which the letter group “A” to “C” is assigned once, so that a letter “A” is indicated on the screen (refer to a screen 4001 shown in FIG. 10). Then, press and hold the “2” key. Upon detecting the “2” key as being pressed and held for a longer period of time than a certain time length (e.g., half a second), the controller 31 changes the letter “A” indicated on the screen to a letter “B”, enters the letter “B” and then shifts the character entry position to a next position. Then, another letter “A” is indicated at the next character entry position (refer to a screen 4002 shown in FIG. 10). If the “2” key keeps being pressed and held in this state, the letter “A” indicated at the next character entry position changes to “B”, “C” and so on to be indicated every certain period of time (e.g., every half a second) (refer to screens 4003 and 4004 shown in FIG. 10).

According to the process of the third embodiment described above, even in a case where characters belonging to a same character group are consecutively entered, a character can be entered and the entered character can be changed by means of a simple press and hold operation. Further, an example was provided as to the third embodiment that an entered character changes every certain period of time (e.g., half a second). Assume, e.g., that the “2” key is pressed and held so that a letter “A” is entered, and that the key further keeps being pressed and held for one second after a change of the character begins. In this case, the entered letter “A” changes to “B”, and then to “C” and is entered. If the period of time for which the key kept being pressed and held after the change of the character begins is measured, and a character in the character group is read out from the memory section 32 in accordance with the measured period of time for which the key kept being pressed and held, and the entered character is changed to the character that has been read out, however, a similar effect of the present invention can be obtained. In this case, assume that the “2” key is pressed and held so that a letter “A” is entered, and that the key further keeps being pressed and held for one second after a change of the character begins. In this case, the letter “A” is entered first, and then a period of time until the “2” key is released is measured by the timer 39. After the “2” key is held for one second and then released, the timer 39 notifies the controller 31 of the period of time for which the key has been held. The controller 31 selects and reads out a letter “C” from the memory section 32 in accordance with data of the period of time for which the key has been held and of the pressed key. Finally, the controller 31 changes the entered letter “A” to the letter “C” that has been read out from the memory section 32 and enters the letter “C”.

### Fourth Embodiment

According to a fourth embodiment of the present invention, as the right shift key is pressed, a character put on the character entry position is entered and the character entry position is shifted to a next position. Further, a certain character included in a character group to which the character just formerly entered belongs is read out from the memory section 32 to the next character entry position. Then, the read-out character is entered on the character entry position. According to the fourth embodiment, as a character which belongs to a same character group is entered by means of the right shift key, the number of times of pressing a key can be reduced in comparison with an ordinary method for entering a character and a character can be entered by means of simple operation.

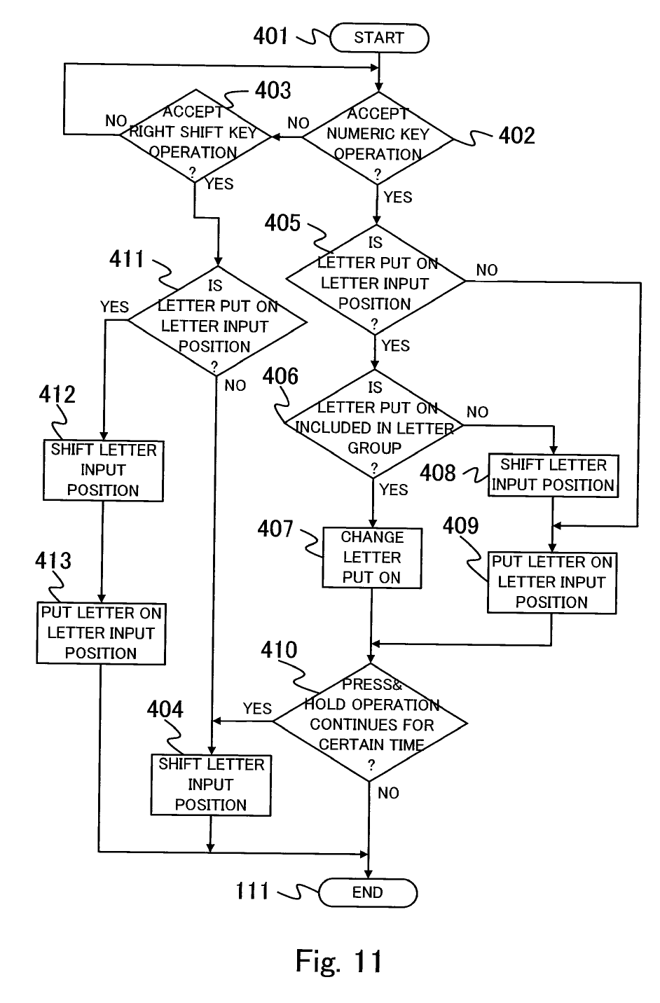

FIG. 11 is a flowchart showing a process for shifting the character entry position and entering a character. A flow of a character entry process will be described below with reference to FIG. 11. Incidentally, as processes of steps 401-410 in the character entry process shown in FIG. 11 are same as the processes of the steps 101-110 in the character entry process shown in FIG. 4, their explanations are omitted. A portion of the flow followed after the step 403 branches off to “YES” will be explained below.

Upon accepting an operation of the right shift key (“YES” of step 403), the controller 31 identifies whether or not a character is already entered on the present character entry position (step 411). Upon identifying no character as being entered on the character entry position (“NO” of step 411), the controller shifts the character entry position one character ahead (step 404), and ends the process (step 414).

Meanwhile, upon identifying a character as being entered on the character entry position (“YES” of step 411), the controller shifts the character entry position to a next position (step 412). Then, the controller 31 recognizes to which character group the character just formerly entered belongs, and further reads out a certain character of the recognized character group from the memory section 32.

Assume, e.g., that the controller 31 accepts an operation of the right shift key in a case where a letter “B” is entered on the character entry position. The controller 31 shifts the character entry position to a next position and recognizes the character group to which the letter “B” just formerly entered belongs. In this case, it is recognized that the letter “B” belongs to the character group formed by three letters “A”, “B”, “C” and their lowercases assigned to the “2” key. The controller 31 reads out, e.g., the front one “A” of the three letters from the memory section 32. Upon reading out a certain character from the memory section 32, the controller 31 enters the readout character on the character entry position that has been shifted (step 413), and ends the process (step 414).

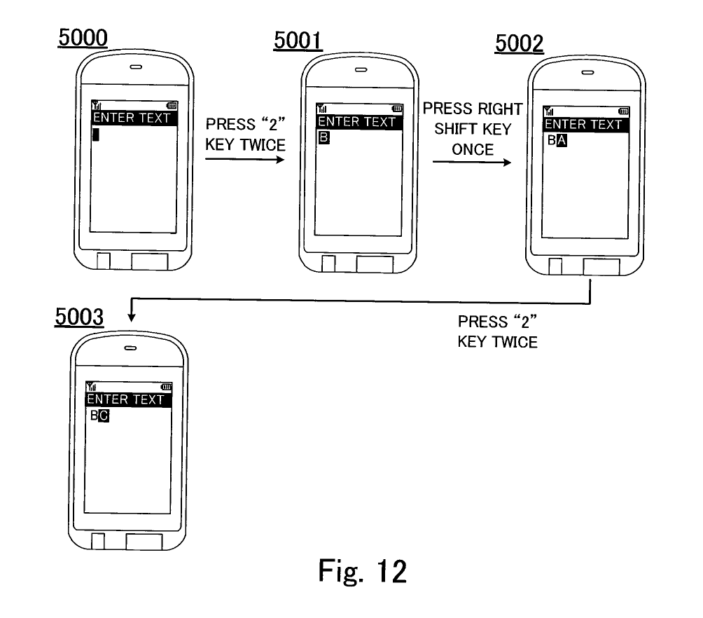

FIG. 12 shows a transition between screens on which the character entry process by means of the right shift key is displayed. A screen transition flow in a case where the letters “B” and “C” are entered will be described with reference to FIG. 12.

In order to enter a letter string “B” and “C”, press first the numeric “2” key twice to which the letter group “A” to “C” is assigned, so that a letter “B” is indicated on the screen (refer to a screen 5001 shown in FIG. 12). Then, press the right shift key so as to enter the indicated letter “B”, to shift the character entry position to a next position and to indicate a letter “A” (refer to a screen 5002 shown in FIG. 12). Further, press the “2” key twice to change the second letter “A” so as to indicate a letter string “B” and “C” (refer to a screen 5003 shown in FIG. 12).

According to the process of the fourth embodiment described above, in order that the characters belonging to a same character group are consecutively entered, the right shift key is pressed so that a character indicated on the screen is entered, that the character entry position is shifted to a next position and that a next character is further indicated. A workload for consecutively entering characters belonging to a same character group can thereby be reduced so that characters can be more simply entered and changed.

Incidentally, the above embodiments are explained in a case where a plurality of alphabet characters are assigned to each of numeric keys. Assume, e.g., that a first group of the Japanese syllabary letters are assigned to the “1” key, a second group of the Japanese syllabary letters are assigned to the “2” key and so on for entering text in Japanese, or that a plurality of symbols is assigned to a numeric key for entering the symbols. For entering text in Japanese, e.g., the first group of the Japanese syllabary letters pronounced as “a”, “i”, “u”, “e” and “o” and the second group pronounced as “ka”, “ki”, “ku”, “ke” and “ko” are assigned to the “1” key and the “2” key, respectively, so that an effect of the present invention can similarly be obtained.

Incidentally, the above embodiments are explained in a case where the operation keys 4 exemplify a component for accepting an operation. Other input devices such as a touch panel, however, can be used for constituting the component for accepting an operation as well as operation buttons to be pressed for input operation, so that an effect of the present invention can similarly be obtained.

Incidentally, the above embodiments are explained in a case where a mobile phone is taken as an example. The present invention is not limited to the above, and can be applied to a wired communication terminal, a PDA (personal digital assistant) or a small-sized data processing device without a communication function. Further, the above embodiments are explained taking a flip-type mobile phone as an example, and the present invention can also be applied to a slide-type mobile phone or a straight-type mobile phone without a moving mechanism. Further, the above embodiments are explained taking the right shift key as an example to which a role of shifting the character entry position is assigned, and such a role can be assigned to various keys such as “*”, “#” or menu keys included in the operation keys 4 so that an effect of the present invention can similarly be obtained.

The present invention is not limited to the above embodiments, and can be implemented by including a modification of each of the portions within the scope of the present invention. The invention may be variously formed by properly combining a plurality of the portions disclosed as to the above embodiments. Some of the portions may be removed from each of the above embodiments.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. An electronic device which allows an entry of a character string, comprising:
a display which indicates an entered character;
a toggle key adapted for entering a plurality of assigned characters;
a shift key adapted for shifting a character entry position on the display, and
a controller which allows consecutive first to third operations, the controller being adapted for entering one of the assigned characters on a first position on the display as the first operation, the controller being adapted for shifting the character entry position from the first position to a second position on the display as the second operation, the controller being adapted for indicating one of the assigned characters at the second position on the display as the third operation, the controller being adapted for allowing consecutive two of the first to third operations by means of either one of the toggle key and the shift key.

2. The electronic device according to claim 1, wherein
the controller is adapted for entering one of the assigned characters on the first position on the display by means of a toggle operation of the toggle key, and
the controller is adapted for shifting the character entry position from the first position to the second position on the display by means of a press and hold operation of the toggle key.

3. The electronic device according to claim 2, wherein
the controller is further adapted for changing the character entered on the first position on the display to another one of the assigned characters by means of the press and hold operation of the toggle key.

4. The electronic device according to claim 2, wherein
the controller is further adapted for entering one of the assigned characters on the second position on the display by means of a toggle operation of the toggle key after shifting the character entry position.

5. The electronic device according to claim 2, wherein
the controller is further adapted for changing the character entered on the first position on the display to another one of the assigned characters by means of the press and hold operation of the toggle key, and
the controller is further adapted for entering one of the assigned characters on the second position on the display by means of a toggle operation of the toggle key after shifting the character entry position.

6. The electronic device according to claim 2, wherein
the controller is further adapted for changing the character entered on the second position on the display to another one of the assigned characters by means of the press and hold operation of the toggle key.

7. The electronic device according to claim 2, wherein
the controller is further adapted for changing the character entered on the first position on the display to another one of the assigned characters by means of the press and hold operation of the toggle key, and
the controller is further adapted for changing the character entered on the second position on the display to another one of the assigned characters by means of the press and hold operation of the toggle key.

8. The electronic device according to claim 2 further comprising a timer for measuring a period of time for which the toggle key keeps being pressed and held, wherein
the controller is further adapted for changing the character entered on the second position on the display to one of the assigned characters in turn in accordance with a period of time measured by the timer for which the toggle key keeps being pressed and held.

9. The electronic device according to claim 2 further comprising a timer for measuring a period of time for which the toggle key keeps being pressed and held, wherein
the controller is further adapted for changing the character entered on the first position on the display to another one of the assigned characters by means of the press and hold operation of the toggle key, and
the controller is further adapted for changing the character entered on the second position on the display to one of the assigned characters in turn in accordance with a period of time measured by the timer for which the toggle key keeps being pressed and held.

10. The electronic device according to claim 2 further comprising a timer for measuring a period of time for which the toggle key keeps being pressed and held, wherein
the controller is further adapted for changing the character entered on the second position on the display to one of the assigned characters chosen in accordance with a period of time measured by the timer for which the toggle key keeps being pressed and held.

11. The electronic device according to claim 2 further comprising a timer for measuring a period of time for which the toggle key keeps being pressed and held, wherein
the controller is further adapted for changing the character entered on the first position on the display to another one of the assigned characters by means of the press and hold operation of the toggle key, and
the controller is further adapted for changing the character entered on the second position on the display to one of the assigned characters chosen in accordance with a period of time measured by the timer for which the toggle key keeps being pressed and held.

12. The electronic device according to claim 1, wherein
the controller is adapted for shifting the character entry position from the first position to the second position on the display and indicating one of the assigned characters at the second position on the display upon the shift key being pressed.

13. A program of an electronic device for entering a character, comprising:
a process for entering one of a plurality of characters assigned to a toggle key of the electronic device on a first position on a display of the electronic device in accordance with how many times the toggle key is pressed as a first operation;
a process for shifting a character entry position from the first position to a second position on the display upon a shift key of the electronic device being pressed as a second operation;
a process for indicating one of the assigned characters at the second position on the display as a third operation; and
a process for allowing consecutive two of the first to third operations by means of either one of the toggle key and the shift key.
